(19) United States
(12) Patent Application Publication
(10) Pub. No.: US 2004/0032629 A1
(43) Pub. Date: Feb. 19, 2004

(54) Individual visual display system

(76) Inventor: Serge Gidon, Murette (FR)

Correspondence Address: Thelen Reid & Priest, P O Box 640640, San Jose, CA, 95164-0640, US

(21) Appl. No.: 10/399,293

(22) PCT Filed: Oct. 12, 2001
(86) PCT No.: PCT/FR01/03166

(30) Foreign Application Priority Data
Oct. 13, 2000 (FR) 00 13140

(51) Int. Cl. G02B 5/32

(52) U.S. Cl. 359/15

(57) ABSTRACT

The invention concerns an individual visual display system for an image displayed on a micro-screen, characterized in that it comprises: image projection means (7) to transform the image displayed on the micro-screen into an aerial image (6) at a short distance from the eye, and image constructing means (5) to transform the short-distance aerial image (6) into an image at infinity, with the projection means and the constructing means being distant from each other.

### FIELD IF THE INVENTION

The invention concerns an individual visual display system enabling a user to view an image too small to be visible to the naked eye.

The invention has applications in numerous fields and, in particular, in the field of communications to enable displaying images displayed on micro-screens of portable multimedia terminals. The invention may enable, for example, viewing images from the Internet and displayed on the micro-screen of a portable telephone; it may also enable viewing the person with whom the user is in telephone communication via a videophone; it may also enable, individually, viewing a film playing on a portable reader, for example, a DVD.

### PRIOR ART

Nowadays, individual communication means are developing very rapidly. The various portable, individual communication devices are increasingly being miniaturized. Consequently, the display screens of these devices have become very small (they are called “micro-screens”); however, the quantity of data to be displayed continues to increase. Thus, even with very good resolution, an image displayed on a micro-screen cannot be properly viewed with the naked eye because of the separating power of the eye. It is thus necessary to add, to these communication devices, an enlarging optical system which enables enlarging the images displayed on the micro-screens to make them visible to the user.

Currently, individual visual display systems mounted on helmets exist. These systems are used for specific professional applications such as military applications or surgical applications. They are not currently developed for personal applications because it is not easy, in everyday life, to wear such a helmet.

Also, there is a visual display system described in the patent application U.S. Pat. No. 4,806,011. This visual display system, mounted directly on a pair of glasses, includes a micro-screen for display associated with optical means enabling enlargement of the image.

This system has the disadvantage of significantly increasing the weight of the pair of glasses and, consequently, of making their use uncomfortable for the user.

Another visual display system designed to enlarge the image of a micro-screen is described in the Internet site www.digilens.com. This system consists of a Bragg reflector mounted on one lens (a half-pair of a pair of glasses) and designed to increase the integration factor of the optical system. This Bragg reflector is implemented by replacing the eyeglass lens with a holographic film, like that described in the article “HOE Imaging in DuPont Holographic Photopolymers”, Diffractive and Holographic Optics Technology, SPIE, V2152, Los Angeles, 1994, by W. GAMBOGI, et al. In this holographic film, a volume hologram has been recorded to diffract the light from a micro-screen at a certain incidence. The holographic film then acts as an aliasing mirror of the system providing, in superposition, the actual view.

This system integrates, on the eyeglass lens, both the imaging optic (in particular, the micro-screen) and the image source, a circumstance which forces the user to wear the entire system on his head, in a manner that is not very elegant and not very comfortable.

Another individual visual display system is the videophone offered by the company KOPIN, which has the form of a portable telephone with a micro-screen for visual display mounted in a hinged manner on the lower end of the phone. This system is described on the website www.kopin.com.

FIG. 1 depicts the optical diagram of the Kopin visual display system. In this system, the user, represented by his eye and reference character 1, looks into a micro-screen 3 placed on the portable phone. A loupe 2 that provides for magnification of the image displayed on the micro-screen 3 is placed above the micro-screen 3. In this FIG. 1, the optical paths R and the B between the points P″1 and P″2 of the micro-screen 3 and the image points P1 and P2 formed on the retina of the eye of the user are depicted, respectively, by light lines and dotted lines. In this system, the rays R and B emitted by the micro-screen 3 are refracted by the loupe 2 (they are then identified with reference character N) and form the points P′1 and P′2 of an image on a virtual screen 4. In other words, the loupe 2 makes it possible to enlarge the image displayed on the micro-screen 3 and thus forms a virtual screen 4 which contains the enlarged image visible to the naked eye. The image of the virtual screen 4 is the image virtually at infinity of the actual image displayed on the micro-screen 3.

In this visualization system, the field angle at which the user sees the screen is larger the closer the screen is placed to the eye. If the user moves the image source, i.e., the micro-screen, away from the eye, the view angle (or field angle) decreases. The visible field of the image thus appears even smaller in the eye of the user. The user is thus forced to look at the micro-screen in a relatively uncomfortable manner because he has to be very close to the micro-screen.

As this visual display system is used in the context of a videophone, the screen is only watched by the user for the duration of a telephone conversation. However, viewing a micro-screen placed close to the eye is uncomfortable; it is thus difficult to imagine that a user could view a series of images on such a screen over an extended period.

### DESCRIPTION OF THE INVENTION

The object of the invention is precisely to remedy the disadvantages of the systems described above. To that end, it proposes an individual visual display in which the image source is disassociated from the imaging optic, i.e., only the imaging optic designed to enlarge the image is placed on a pair of glasses, with the image source designed to create the image to be viewed being placed at a distance from this pair of glasses.

More precisely, the invention concerns a visual display system for an image displayed on a micro-screen and comprising:

image projection means to transform the image displayed on the micro-screen into an aerial image at a short distance from the eye, and

image constructing means to transform the short-distance aerial image into an image at infinity, with the projection means and the constructing means being distant from each other.

Advantageously, the constructing means comprise an eyeglass capable of transforming the image rays into parallel rays and focusing the illumination rays.

Preferably, the eyeglass has at least one holographic optic. The eyeglass may consist of a pair of glasses of which each lens has a holographic film.

The projection means may include at least one light source emitting illumination rays and one projector emitting image rays. Advantageously, the source may have a spectrum with a discrete wavelength or discrete wavelengths.

The constructing means may be placed along an axis different from that of the projection means.

### BRIEF DESCRIPTION OF THE FIGURES

FIG. 1 already described, depicts the optical path in a Kopin system;

FIG. 2 depicts the general optical diagram of a image point in the system of the invention;

FIG. 3 depicts the optical diagram of a plurality of image points in the system of the invention; and

FIG. 4A and 4B depict the optical diagrams of two image points in two embodiments of the invention.

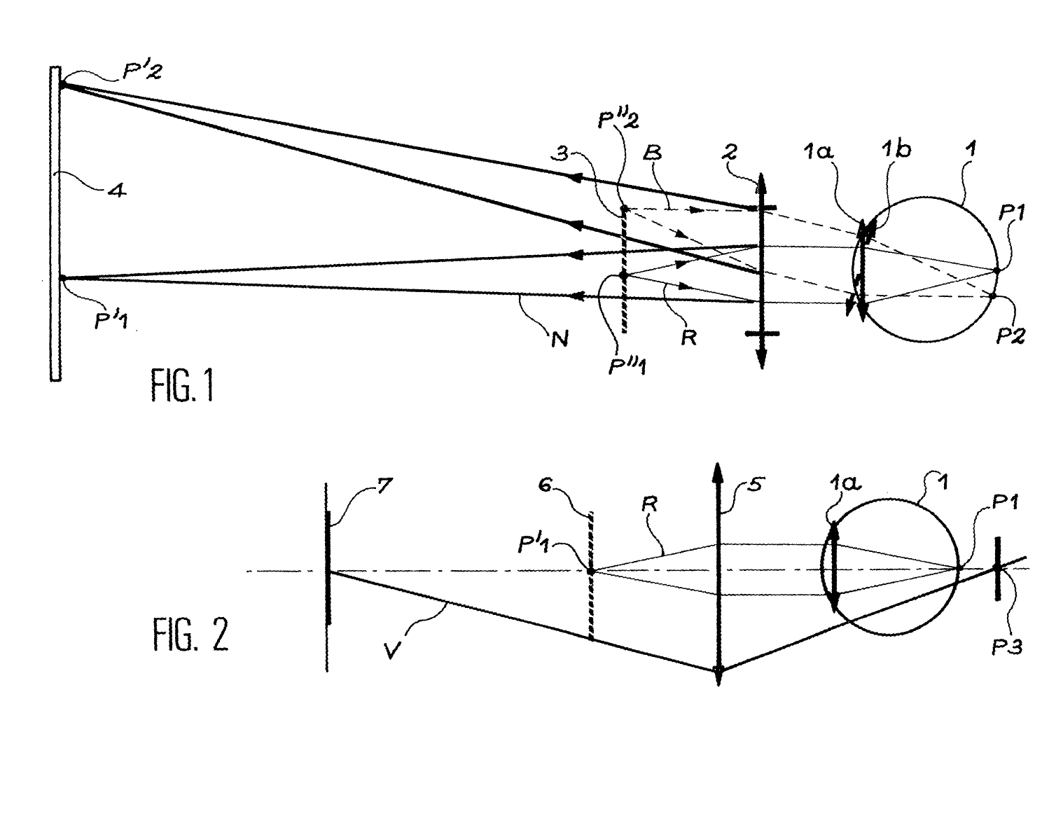

### DETAILED DESCRIPTION OF THE EMBODIMENTS

The invention proposes an individual visual display system in which the image source is disassociated from the imaging optic and distant from the eye, rendering the system comfortable and ergonomic for the user.

The invention proposes resolving the difficulty associated with the distancing of the image source (explained in the description of the Kopin system), by projecting an aerial image in front of the eyes of the user. This aerial image at a short distance from the eye may only be seen by the user's eye if the light rays that pass through this image also enter the eye. It is thus necessary to select a convergent viewing optic, near the eye, that acts both as an aperture optic to collect the light in the system and at the same time acts as a loupe to enable accommodation of the eye at a distance adequately small to have the viewing angle desired, i.e., to transform the short-distance image into an image at infinity.

This viewing optic is implemented by an eyeglass that can have the form of a pair of glasses.

The visual display system of the invention is thus disassociated into two parts, i.e., the image source (also called image projection means) which may be held at arm's length and the viewing optic (also called image constructing means), placed near the eye and capable of being worn on the user's head.

FIG. 2 depicts the general optical diagram obtained by the system of the invention. In this diagram, the user's eye is identified with reference character 1, the viewing optic (or image constructing means) 5, the image source (or image projection means) 7, and the aerial image seen by the eye 6.

One of points of this aerial image 6 is identified by the reference character P′1. This point P′1 is formed on the retina of the eye in a point P′1. The optical path enabling receiving the point image P′1 in the eye, from the image P′1, is identified by the reference character R.

In order for the rays to form an image point on the retina of the eye, it is necessary that these rays arrive in parallel on the pupil of the eye, which then provides for their focusing. As can be seen in FIG. 2, the rays R from the image point P′1 are made parallel by the dioptric effect (loupe) of the eyeglass 5. These rays R are then focused by the crystalline lens of the eye on a point P1 on the retina.

In addition, in order for the point P1 to be detected by the eye, it is necessary that the eye also receive light. This light, or illumination, is depicted in FIG. 2 by the optical path V. This illumination V comes directly from the image source 7 and is directed into the eye by the eyeglass 5; the eye can thus detect the image point P′1 along with a certain light, so as to make this image point visible.

The cone of light defined by the illumination rays V must be, at the level of the eye, adequately wide to enable viewing despite ocular movements.

This FIG. 2 also shows that an aerial image 6, i.e., an immaterial image, is created at the location where the micro-screen was in the prior art of Kopin. Thus, the system of the invention enables not only creating this aerial image, but also making this aerial image visible to the eye. For this, the eyeglass 5 plays a dual role:

it permits accommodation of the eye to the aerial image, which is too close to the eye to be viewed naturally without adaptation;

it permits collecting the light rays from the image source 7 to deflect them toward the eye to illuminate the image in the eye.

According to a preferred embodiment of invention, the eyeglass is implemented in the form of a pair of glasses of which each lens is covered by a holographic film. This holographic film has, in fact, the characteristic of introducing an optical power at discrete wavelengths (for example, red, green, and blue) while also being transparent to natural light. Such glasses thus provide “enlargement” of the aerial image without interfering with natural vision. The sources may be, for example, lasers, LEDs, etc.

The lenses of the these pairs of glasses are thus each covered with a holographic film made of a material such as that described in the patent application U.S. 5,470,662.

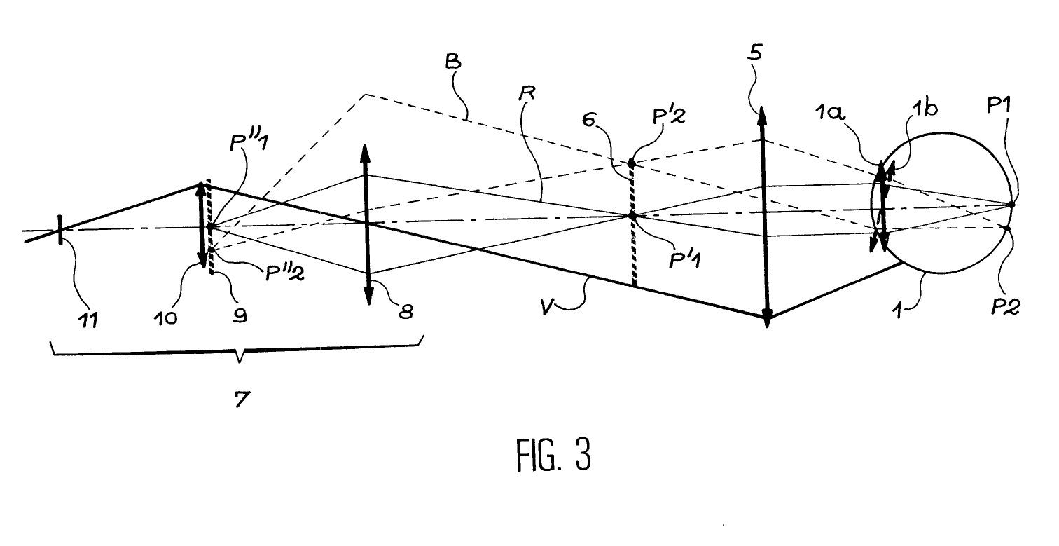

FIG. 3, depicts the optical diagram of the preferred embodiment of the invention. In this embodiment, the elements already referenced and described in FIG. 2 have identical reference characters.

This FIG. 3 depicts, in greater detail, the image source 7. This may be, for example, implemented as a micro-screen 9 displaying a real image. The term “micro-screen” refers to any maintenance displaying an image of very small size, i.e., an image to small to be viewed by the eye without an intermediate device.

The micro-screen may be associated with a field lens 10 and a projection lens 8 (also referred to as projector). The field lens 10 has a size equal to that of the screen and a focal length on the order of a few centimeters. This field lens serves to direct the illumination rays toward the pupil of the eye, taking the position of the eyeglass into account. The projection lens 8 constructs the aerial image.

The aerial image may come from a micro-screen, for example, of the LCD type (with a step size from 10 to 20 μm and a VGA, SUGA, or XVGA format) or any image synthesis means taking advantage, for example, of the effect of retinal perception, as proposed in the patent WO 98/41893.

Only for reasons of simplification of the description, the case of the image displayed on a micro-screen shall be described.

The micro-screen can be associated, upstream, with one or a plurality of light sources 11 emitting a light at one or a plurality of specific wavelengths. This may be, for example, a trichromatic light source, i.e., emitting red, green, and blue light. In this case, the holographic film is composed of three layers of holographic material, in thin films, in order to respectively diffract the wavelengths of red, green, and blue.

The light sources may be, for example, RGB LEDs (“light emitting diode”), with low line widths (for example, 30 nanometers) so that the holographic eyeglass effect is efficacious. These sources, which may have a small geometric size, are of interest in reducing the aberrations of the optical system. In fact, each pixel of the micro-screen subtends only one narrow beam of light that enables relaxing the design constraints of the eyeglass hologram.

The distance between the projection lens 8 and the eyeglass 5, which corresponds to the distance between the image source and the user, defines the enlargement factor of the aerial image of the screen. Since the aerial image must be geometrically smaller than the eyeglass, the size of the screen must be as small as possible, for example, smaller than a centimeter, as is often the case in current micro-screen technologies.

The projection lens, which is near the screen, has a focal length as long as possible given the bulk constraints; it can be, for example, a few centimeters. Advantageously, the projection lens 8 may be of the “telephoto” type, not necessarily corrected for chromaticism, as the eyeglass may contribute, by its design, to this correction.

Also, since the aerial image delimits a cone of light from the projection means 7, this cone, must be proportioned to the dimensions of the eyeglass, a situation which sets its size at approximately 20 mm to 40 mm.

In addition, the position of the aerial image in front of the eyeglass is a function of the field angle desired. To maximize this field angle, a focal distance of the eyeglass of less than 50 mm is selected.

In FIG. 3, it is discernible that the image rays with the reference character R originate from a point P″1 of the micro-screen 9, i.e., from the real image displayed on the micro-screen 9. These rays R, emitted by the point P″1, are focused by the projection lens 8 to form the aerial image 6 and, in particular, the point P′1 of this aerial image. These rays R are then transmitted, in parallel, by the eyeglass 5 onto the pupil of the eye, which, in turn, focuses these rays R to form a point P1 in the eye. Likewise, the rays B are emitted initially by a point P″2 of the real image displayed on the micro-screen 9. These rays B are focused on the projection lens 8 to form the aerial image 6 and, in particular, the point P′2 of the aerial image 6. These rays B are then transmitted, in parallel, by the eyeglass 5 onto the pupil 1b of the eye, which then forms the image point P2 on the retina of the eye.

It should be noted, in this FIG. 3, that the pupil of the eye has different reference characters that depend on the orientation of the rays received by the eye.

This FIG. 3 clearly shows that there is a point-by-point correspondence between the points of the real image and the points of the aerial image of between the points of the aerial image and the points on the retina of the eye.

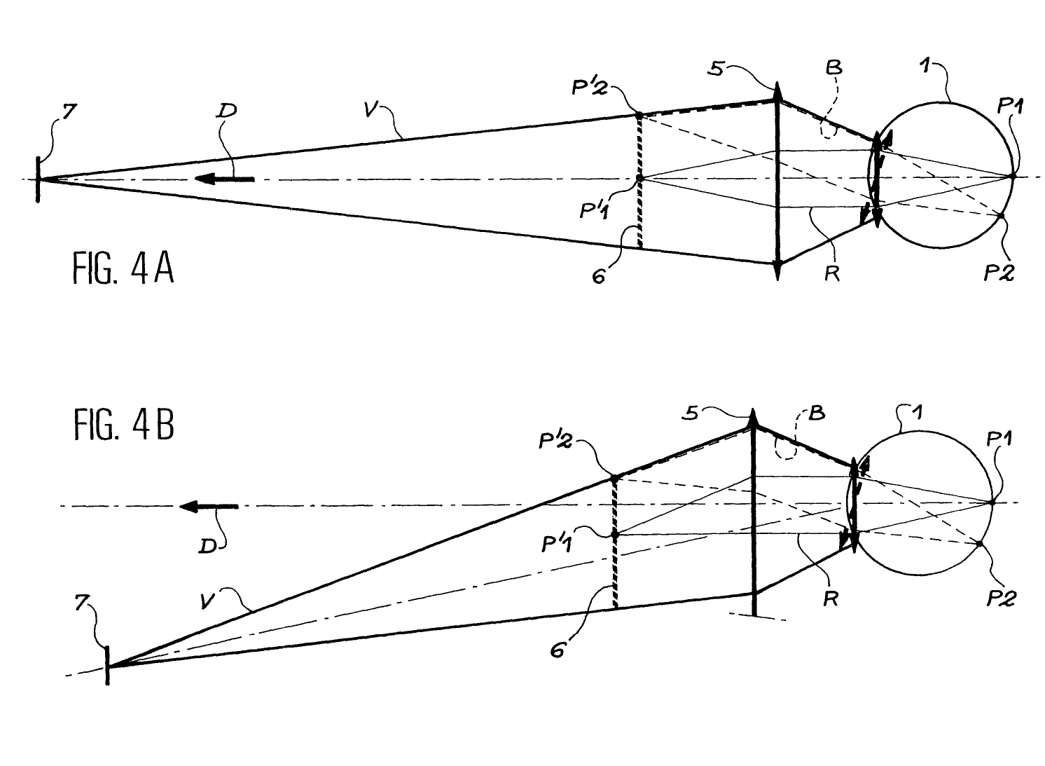

FIG. 4A and 4B depict the optical diagrams of visual display of the aerial image 6, respectively, in the case where the projection means are on the same axis as the line of vision of the eye and in the case where the projection means are off-axis relative to the direction of the line of vision of the eye.

The reference characters in FIG. 4A and 4B are identical to the reference characters in FIG. 2 and 3. Only the reference character D was added; it represents an arrow showing the direction of the line of vision.

FIG. 4A depicts the case in which the projection means 7 are aligned relative to the line of vision of the eye 1, as was the case in the explanations of FIG. 2 and 3.

FIG. 4B depict the function of the system of the invention, off-axis. In this case, the projection means 7 are off-axis relative to the direction D of the line of vision of the eye. This figure shows that, even in this case, the illumination rays V are transmitted to the eyeglass 5, which redirects them to the pupil of the eye 1. In this case, the aerial image 6 is created asymmetric relative to the axis D, but the rays R and B are processed in a manner identical to the case in FIG. 4 A and arrive in an identical manner on the retina of the eye. In fact, the eyeglass provides an optical function of convergence which may be designed for off-axis operation, i.e., for an asymmetric system, a situation which frees the field of normal vision. This is implemented, for example, by a specific design of the hologram of the eyeglass.

1. System for visual display of an image displayed on a micro-screen, characterized in that it comprises:
image projection means (7) to transform the image displayed on the micro-screen into an aerial image (6) at a short distance from the eye, and
image constructing means (5) to transform the short-distance aerial image (6) into an image at infinity, with the projection means and the constructing means being distant from each other.

2. System according to claim 1, in which the image at infinity is made up of image rays and illumination rays, characterized in that the constructing means comprise an eyeglass capable of both transforming the image rays into parallel rays and focusing the illumination rays.

3. System according to claim 2, characterized in that the eyeglass includes at least one holographic optic.

4. System according to claim 2 or 3, characterized in that the eyeglass consists of a pair of glasses of which each lens comprises a holographic film.

5. System according to any one of claims 1 through 4, in which the projection means comprise at least one light source (11) emitting illumination rays and one projector (8) emitting image rays.

6. System according to claim 5, characterized in that the source emits a light with a spectrum with a discrete wavelength or discrete wavelengths.

7. System according to any one of claims 1 through 6, characterized in that the constructing means are placed along an axis different from that of the projection means.
